(19) United States
(12) Patent Application Publication
(10) Pub. No.: US 2014/0279281 A1
(43) Pub. Date: Sep. 18, 2014

(54) ADMINISTRATION SYSTEM AND METHOD FOR PRODUCT DELIVERY

(71) Applicant: ParcelPoke Limited, Brighton (GB)

(72) Inventor: RICHARD JOHN TOLCHER, Brighton (GB)

(73) Assignee: ParcelPoke Limited, Brighton (GB)

(21) Appl. No.: 14/217,072

(22) Filed: Mar. 17, 2014

Related U.S. Application Data
(63) Continuation of application No. 13/843,448, filed on Mar. 15, 2013.

(51) Int. Cl. G06Q 10/08; G06Q 30/06

(52) U.S. Cl. CPC G06Q 10/0838; G06Q 30/0637
USPC 705/26.82; 705/341

(57) ABSTRACT

An order placement and delivery system is provided in which a final delivery address of a recipient is obscured or not known to a sender. The sender places an order for a gift against the unique sender identity, relays to the administrator a recipient's virtual contact address, and constructs a personal message which is routed to the virtual contact address. The point of origin of the personal message is inferred to be directly from the sender. The personal message forewarns the recipient that they will be messaged by the administrator to acquire a real-world physical address that will be used for physical gift delivery and stored in the database against the virtual contact address, such that future orders identifying the recipient's virtual contact address can be dispatched expeditiously to the recipient's physical address with reduced messaging overhead and without having to reveal the recipient's physical address to the sender.

### CROSS-REFERENCE TO RELATED APPLICATIONS

This application is a continuation of U.S. application Ser. No. 13/843,448, filed Mar. 15, 2013, which is hereby incorporated by reference herein in its entirety.

### BACKGROUND TO THE INVENTION

This invention relates, in general, to an administration system and method for product delivery and is particularly, but not exclusively, applicable to a gift delivery process that is initiated by a transaction established over a communications network, such as the internet, and fulfilled with delivery of an order to a third party.

### SUMMARY OF THE PRIOR ART

In the context of on-line ordering, the “one-click” approach by Amazon® allows a registered user to make use of stored sensitive personal data, such as bank details, to obviate the need to re-enter and re-transmit such sensitive data over a wide area network, such as the Internet. At the point of each “one-click” order, the ordered product or gift is delivered to an address that is defined and always known (both to the account holder and the vendor, i.e. Amazon). In fact, one-click, whilst more efficient from the perspectives of data traffic, security and both rapidness and accuracy of data entry, the system requires, from the outset, the identification of the recipient address. This recipient address (which may be the user's home postal address) is logged against a user account.

There are also issues relating to the veracity of email notifications. For example, in the context of a gift, the recipient potentially has no idea that such a gift has been ordered until: (i) the gift physically arrives; (ii) they are notified directly by the account holder responsible for ordering the gift, e.g. making use of direct recipient contact through chat on a social media site; or otherwise (iii) a notification email is received by the recipient from either the supplier or a delivery company tasked with physical delivery. Unfortunately, with growing levels of cyber-attack arising both in malicious email attachments and spam emails, any notification email may be viewed by a gift recipient with some cynicism, if not entirely ignored. A question therefore remains about how assurances can be provided to a recipient that the email notification is bona fide and that the email address is that of a trusted delivery organization tasked with delivery of any physical gift.

### SUMMARY OF THE INVENTION

According to a first aspect of the invention there is provided a method of delivering a product to an order recipient having a real-world delivery address potentially unknown to a registered user responsible for placing an order for the product at an administration system configured to manage order transactions for registered users and to authorize delivery of products to order recipients, the method comprising: over a communications network, communicating an order message from a communication device to the administration system, the order message including a unique sender identity associated with the registered user, a virtual recipient address of the order recipient and a transaction instruction related to the product to be delivered to said order recipient; at the communication device, generating at least part of a personalized message and initiating electronic communication thereof to the virtual recipient address; at the administration system, receiving the order message and approving delivery of said order subject to correlating the unique sender identity against a registered account for the registered user and settling the transaction instruction against the registered account; at the administration system, sending a downlink call message to the virtual recipient address, the downlink call message designed to solicit return of, or confirm, a real-world delivery address from the order recipient; at the administration system, subsequent to receipt of the requested real-world address in a message sent from the virtual recipient address, resolving a relationship between the virtual recipient address and the real-world delivery address and instructing delivery of the product to the real-world delivery address of the order recipient.

In a preferred embodiment the method may comprise sending the personalized message indirectly to the virtual recipient address by relaying the personalized message through the administration system; and upon relaying the personalized message to the virtual recipient address in a first electronic message, obscuring involvement of the administration system responsible for relaying the personalized message by spoofing the header of the first electronic message.

The first electronic message may be augmented with registered user attributes stored at the administration system.

The administration system may attempt to use a stored real-world delivery address (cross referenced against the the virtual recipient address) for future orders addressed to the same order recipient.

In one embodiment, the method further comprises: instantiating an OrderApp on the communication device; placing an order by communicating the order message to the administration system; temporarily dropping out of the OrderApp to configure and send a personalized electronic message directly to the virtual recipient address; and at the administration system, sending the downlink call message after a delay, upon receipt of the order or after notification that the personalized electronic message has been sent to the virtual recipient address.

In a second aspect of the present invention there is provided an administration system configured to manage order transactions of registered users and to authorize delivery of products to order recipients, the administration system comprising: a server configured: to receive and be responsive to an order message having a unique sender identity associated with a registered user, a virtual recipient address of a first order recipient and a transaction instruction related to a product to be delivered to said first order recipient; to approve delivery of said product subject to correlating the unique sender identity against a registered account for the registered user and settling the transaction instruction against the registered account stored in a database of registered users; following sending of a personalized message referring to the order, to assemble and send a downlink call message to the virtual recipient address, the downlink call message soliciting return of, or confirmation of, a real-world delivery address from the order recipient; to receive the solicited real-world address in a message received from the virtual recipient address; and to resolve a relationship between the virtual recipient address and the real-world delivery address, whereafter the server is arranged to issue an instruction for delivery of the product to the real-world delivery address of the order recipient.

The system may be arranged to receive at least part of the personalized message from the registered user, with the server configured to initiate electronic communication thereof to the virtual recipient address. The server may augment the personalized message with registered user attributes that are stored in the database.

In a particular embodiment, the server receives the personalized message from a networked communication device and is further arranged to relay the personalized message to the virtual recipient address, the server configured to spoof the header of the first electronic message to suggest direct communication of the personalized message as originating from the networked communication device.

In another aspect of the invention there is provided a web-server of an on-line retailer, the web-server presenting a web page through which retail activity may be managed by the web-server, the web-page including a web portal that links through a network to the administration system of the second aspect and wherein the administration system is configured to: set-up and manage an order or transaction; administer account settlement; and resolve real world delivery addresses.

The web portal may be configured such that, at completion of an online order by a user, the user is prompted to generate a personal message to an intended recipient of the online order and the administration system is arranged, upon receipt of the personal message, to communicate the personal message to the intended recipient.

The administrator is preferably arranged to: conclude the sales transaction and to link the sales transaction to the on-line retain; and arrange dispatch and delivery to the real world delivery address.

The web portal is furthermore preferably configured such that, at completion of an online order by a user, a communication session between the web-server and the administrator is established and the user, wherein the communication session permits the administration system to acquire information pertaining to at least the retailer and the virtual recipient address of the intended recipient.

The web-server is preferably configured to receive a confirmatory message from the administration system that said order has been completed by the administration system and wherein the web-server is further arranged to send an order completion message to an order processing system of the online retailer, the order completion message causing the order processing system to dispatch the order directly to the intended recipient.

In yet another aspect of the invention there is provided a network-based ordering system comprising: a plurality of communication devices configured at least to assemble and send text messages; a telco router responsible for routing text messages, the telco router including an API arranged to execute control logic to administer and process messages received from the plurality of communication devices; a rule engine coupled to the telco router, the rule engine arranged to interact with the API, the rule engine defining telco interactions and identities of communication devices subscribing to the network-based ordering system; and an administrator for managing retail sales, the administrator coupled to the router through a network; wherein the API is configured to intercept text messages from those communication devices that have subscribed to the network-based ordering system and to interrogate such intercepted text messages for the presence of a trigger word or trigger image and wherein the API is further configured, based on said defined telco interactions, to route messages containing to the trigger word or trigger image to the administrator and otherwise to pass those text messages not containing the trigger word, and wherein the administrator is configured to receive those intercepted messages containing the trigger word or trigger image for processing and acquisition of an order for goods or services.

A database, coupled to the administrator, contains account data for a plurality of subscriber and the administrator is configured, in response to receipt of an intercepted message, to reference and access a corresponding subscriber account in the database to complete the order for goods or services.

The administrator may, upon order completion and deduction of payment against the corresponding subscriber account, be arranged to compile and send a message to a retailer instructing release of the goods or services to an address logged against the corresponding subscriber account.

In a further aspect of the invention there is provided a network router responsible for routing text messages, the telco router including: an API arranged to execute control logic to administer and process messages received from the plurality of communication devices; a rule engine arranged to interact with the API, the rule engine defining telco interactions and identities of communication devices subscribing to the network-based ordering system; wherein the API is configured to intercept text messages from communication devices subscribing to the network-based ordering system and to interrogate such intercepted text messages for the presence of a trigger word or trigger image and wherein the API is further configured, having regard to said defined telco interactions, to: i) route messages containing to the trigger word or trigger image to an administrator responsible for managing text message based sales; and ii) pass those text messages not containing the trigger word or not from subscribing communication devices to an end recipient that is not the administrator.

Advantageously, embodiments of the present invention allow physical articles, including ordered gifts, to be delivered to a recipient without the sender knowing the recipient's physical and real-world delivery address. The system can also resolve changes in the recipient's delivery address even these are unknown to the sender. A system of instant gift messaging over, especially, a cellular radiotelephone backbone is therefore envisioned and provided by some of the preferred embodiments.

Beneficially, the present invention furthermore allows a user the ability to purchase goods through interactive smartphone exchanges with a transaction management site accessed via a web portal on a third party retailer site. The system of the present invention therefore augments cellular phone functionality and usage by providing a mechanism for ordering or reserving gifts or services.

The various aspects of the invention as outlined in the appended claims can be implemented as a hardware solution or as software.

### BRIEF DESCRIPTION OF THE DRAWINGS

Exemplary embodiments of the present invention will now be described with reference to the accompanying drawings in which:

FIG. 1 is a network architecture that supports multiple operating methodologies for various gift delivery and messaging processes of multiple embodiments of the present invention;

FIG. 2 is a flow diagram of a preferred registration process;

FIG. 3 is a flow process, implemented within the network of FIG. 1, of a preferred gift delivery service based on indirect message routing to a recipient;

FIG. 4 is a flow process showing a preferred gift delivery process for a registered recipient;

FIG. 5 is a flow process, implemented within the network of FIG. 1, of a preferred gift delivery service based on direct message routing to a recipient; and

FIGS. 6a and 6b collectively represent a flow process through a “text-yourself” ordering methodology according to another aspect of the invention.

### DETAILED DESCRIPTION OF A PREFERRED EMBODIMENT

FIG. 1 is a network architecture 10 that supports multiple operating methodologies for various gift delivery and messaging processes of multiple embodiments of the present invention.

Based around a network 12 that may employ wireless and/or wireline data transfers at different times or consequential of overall network topography, a first device 14, such as a networked computer or a smartphone, is connected through the network 12 to an administrator 16. The first device 14 can therefore be considered to be one of many and a “sender” of an order instruction.

The administrator 16, such as a server, is coupled to a database 18 that stores account data, including mapping of unique virtual identities registered to an account and recipient physical address data. Indeed, the database 18 may include multiple virtual identities to each physical address. The administrator 16 is operative to manage accounts and orchestrate delivery of gifts ordered against a registered user account from the sender 14. The administrator 16 therefore contains a processor and control logic, whereby processor and control logic are arranged to register new accounts, maintain and map existing account identities and physical addresses and to resolve trigger events received from the sender 14 to initiate messaging and, eventually, bring about delivery of goods or services to a recipient 22. The administrator 16 therefore acts as a human machine interface (HMI) allowing a user to place an order (such as via an SMS or email sent through the network 12), whereafter the control logic in the administrator 16 is tasked with fulfillment of the order and engagement of a supplier 24 (again typically through an instruction sent through suitable interface protocols used by the network 12). The administrator 16 may therefore be realised as a web server.

The supplier 24, upon being contacted (such as via an email instruction), can then arrange delivery of any ordered gift 26 to the recipient 22.

1. Establishment of an Account

Referring to the flow diagram of FIG. 2, an account set-up process 100 is shown.

In the context of a mobile device based sender 14, the sender initially loads 102 a gift ordering and delivery application (“OrderApp”) into memory of the mobile device for execution by the mobile device's processors. The OrderApp (which could also be based on a web browser) provides a human machine interface and, through a data connection, an access point to a management system (such as a web site) of the administrator 16. As indicated above, once registered, the sender 14 is able to place orders that are serviced and fulfilled by the control logic at the administrator 16.

Upon instantiation of the OrderApp, a communication session 104 is established (via one or more networks 12) with the administrator 16. If not previously registered (decision block 106), the sender registers 108 with the administrator by providing 112 financial account details against which charges for products can be made and, furthermore, settles 110 a unique sender identity that is recorded in the database 18. It is preferable that, from the outset, the financial account details are cross-referenced against the unique identity so as to facilitate ease of ordering and minimal authentication in any sender-to-administrator contact. The unique sender identity is, however, generally tied to and recorded against the mobile device address or phone number and could, subject to access, simply be a unique SIM card number or an IP address or social networking identity that is sent automatically to the administrator 16 upon establishment of a call. Alternatively, the unique sender identity could be a log-in name that is easy to remember by the sender and which log-in name is entered by the sender and sent in an uplink message to the administrator to permit opening of the relevant sender account. The sender identity can, in fact, be any authenticable virtual identity.

With the sender account open and active, the sender may place 116 an order for a gift, such as a bunch of flowers or a box of chocolates (by way of limited example to a physical gift or supplied service). The sender 14, however, does not need to identify a physical address for any recipient 22. Instead, the sender 14 is required merely to identify the recipient to allow the administrator 16 to contact the recipient 22 and effect delivery of an ordered gift 26. The sender's account may include a variety of acquired and recorded 114 sender attributes that can be used as tags in a message to authenticate origin, e.g. the attributes may include (but are not limited to) the sender's physical address, cellphone and/or landline telephone number. The sender's account may typically also include an agreed security password or code that is used for authentication purposes to verify that the remote sender 14 is who they say they are.

In the event that the recipient has not previously been registered in the database 18 by the administrator, a messaging and delivery process proceeds in one of two ways, but regardless of the selected one of the two alternative ways there are always two messages initially communicated to the a new recipient: (1) a first personal message that is delivered directly by, or seemingly delivered from, the sender 14 to the recipient 22; and (2) a short code or message expressly sent by the administrator 16.

There is both an indirect and a direct route for sending the first person message; the choice is generally subject to national telecommunication standards.

Indirect Route and First Contact

The indirect route operates in the following fashion and with reference to FIG. 3.

FIG. 3 is a flow diagram of a preferred gift delivery process 200 based on an indirect message routing to a recipient

The sender 14 instantiates the OrderApp and selects 200 a product or service for delivery. The OrderApp allows the user to enter 202 a personal message intended for the recipient, which message is then communicated to the administrator 16. Contemporaneously, the sender 14 also selects and then effects an order for a particular gift 26 since the personal message relates to gift delivery. Indeed, the order will require some form of monetary transaction to be managed and completed 206 by the administrator. Additionally, the order requires the sender to identify and communicate to the administrator a virtual contact address 204 of the recipient, e.g. an authenticated cellphone or landline number. In establishing contact to the administrator 16, the sender 14 is explicitly and uniquely identified to the administrator, e.g. through the use of the unique sender identity.

Upon receipt by the administrator 16 of the personal message and the virtual contact address, the administrator operates to relay 210 the personal message in a downlink personal message to the recipient's virtual contact address. However, the act of relaying the downlink message “spoofs”, i.e. fakes, the originating address (such as by replicating the message header) so that, from the recipient perspective, the personal message is understood/seen to have come directly from the sender 14 rather than being routed through or sent from the administrator 16. Spoofing or faking the downlink personal message is typically and optionally augmented with a notification that says, in essence, that the recipient 22 has been sent a gift 26 by the sender and that the recipient 22 will be subsequently contacted by the administrator 16 in a second independent message asking for delivery details. The “spoofing” of faking of the originator address by the administrator therefore engenders a level of trust at the recipient given that the recipient not only receives a personalised message from the sender 14 but also that, seemingly, the personalised message has source credentials that tie back to the sender's physical address, authenticated cellphone and/or landline telephone number. Source credentials that are recovered from the sender's account can be populated into the relayed personal message or as meta data into the relayed downlink personal message, with this process optional and potentially required, as will be understood, should the original uplink personal message from the sender be insufficient (decision block 208) by including only a password or partially obscured sender identity. The administrator 16 may therefore be configured to augment 210 the original personal message by ‘filling in the gaps’ in the downlink personal message so that the recipient can glean a level of confidence that the message is not spam, but rather a genuine attempt to provide a real-world gift ‘without any strings attached’. The administrator's control logic is therefore configured to populate the downlink message with authenticated data and in accordance with rules established at the set-up of the administrator's function.

With the header spoofed or faked 212, the personal message can then be sent 214 in its original (sufficient) form or otherwise in an augmented form.

Spoofing or faking therefore permits the intended recipient to infer that the personal message associated with the intended gift has indeed been sent from the sender 14 (and not an unknown third party). Spoofing therefore brings about an ability to attribute a message data field (e.g. a sender's CallerID) with the origin sender, rather than the relay point. Increased levels of trust mean that higher proportions of gifts will be claimed by the identified recipients.

After relaying the downlink personal message, the administrator independently operates to send 216 a second downlink call message to the recipient. The downlink call message is sent to the recipient's virtual contact address as provided by the sender. The downlink call message includes a gift or sender reference (whether visible or invisible to the user) that cross references to the sender's gift order and/or account.

On a first order to a particular recipient, the administrator logic needs to acquire 218 a response to the downlink call message sent to the intended recipient.

Preferably, the downlink call message expressly refers to the previously communicated downlink personal message so as to establish a visible association between the administrator 16 and the sender 14 and their gift 26. The downlink call message asks that the recipient reply to the downlink call message to claim the gift and thereby to supply a physical address to be used as an actual, real-world delivery address for the gift 26. The nature of the uplink reply can take a number of forms, but need to include the gift or sender reference to ensure that the control logic at the administrator can resolve the delivery address against a specific order. For example, a direct reply in a text message is one option for the uplink reply, but equally the reply could be via another communication platform, such as an email or a telephone call.

Once the administrator receives 220 the recipient's real-world delivery address in the uplink reply, the administrator 16 is configured to manage 222 the response and subsequently arrange 224 dispatch of the gift 26. The point of dispatch may be used to trigger a status update on the delivery of the gift, and this status update can be sent to one or both of the sender 14 and/or the recipient 22.

If no response is received 226 from the intended recipient, the administrator may again try 228 to contact the intended recipient by re-sending the downlink call message or otherwise the administrator may optionally cancel 230 the order after a time-out 232 (such as or fixed number of contact attempts or absolute time) has expired 234.

Registered Recipient

The administrator 16 is configured to operate to associate and record (step 222 of FIG. 3) in its database the real-world delivery address against the virtual address of the recipient, thereby establishing a registered recipient in the database 18. The cross-referencing between the virtual address and the real-world delivery address of the recipient can be used (affirmative route 300 from decision block 302) subsequently to negate the requirement to send the downlink call message at the point of a subsequent order to the same recipient and regardless of whether the subsequent gift is from a common sender 14 or someone entirely different. The administrator is therefore arranged automatically to manage any sender order (FIG. 4) to a known registered recipient and to oversee sending 304 of the gift 26 to the physical address of the recipient. Expressing this differently, the database's recipient record supports the automatic reference to an existing physical address and the automatic delivery of gifts to be sent to the recipient's physical address without intervention by with the sender 14 or the recipient 22.

Of course, the administrator 16 may continue (306) to send alert messages concerning subsequent gifts, with these alerts now received from the administrator acting in the capacity of a “known” source with whom the recipient has had previous and successful and legitimized interactions. Any alert messages from the administrator to the recipient's virtual address also permit the recipient to respond 308-310 and update 312 a physical address to which a (subsequent) new gift can be delivered 314 and this update can be aided by intelligent administrator rules to remind recipients when a delivery address change might occur. The administrator can, in response to a reply to the alert, therefore update 316 its internal database by replacing an existing real world recipient address with an updated real-world recipient address.

A registered recipient may also access the administrator and have the virtual address expunged or otherwise the cross-referenced physical address (related to the recipient's virtual address) changed or updated in the database 18.

The database 18 may include many virtual addresses mapped to a single physical address.

The registered recipient is therefore not tied to the originating sender responsible for sending the first gift to the recipient. Also, from a security perspective, the sender 14 never needs to know the real-world physical address of the recipient and, moreover, the recipient can prevent someone registering a physical address against a virtual identity given that only both are known to the recipient. The secure nature of the database 18 and the administrator therefore prevent direct release of the recipient's virtual identity and the physical real-world address. And any changes to the physical address (as mapped to the virtual recipient address in the database 18) are irrelevant to any sender, with the update in the registered recipient record occurring seamlessly without any sender's knowledge or action.

The OrderApp may, furthermore, provide access to the database 18 to allow a sender to select a gift (such as an offered service) for delivery to a virtual identity selected from a universe or otherwise subset or limited sorted subset of digitally-stored virtual addresses; this is particularly valuable in a marketing context. By way of explanation, subscription or enrollment data sometimes contains limited personal information that, following owner consent, is subsequently made available to affiliate companies. A company or organization may therefore base a marketing campaign on a selected demographic profile selected as relevant to the marketing interests of the company or organization. To incur the costs associated with providing a sample for testing or appraisal purposes, the company therefore need only identify itself (for reasons of engendering trust) and select virtual addresses to which the sample is potentially to be sent. The company is therefore not exposed to delivery costs for samples that may, in fact, be immediately discarded if physically delivered, since the recipient is responsible for providing their real world delivery address in response to an offer to supply and the sample is only sent after a positive from a virtual address. The recipient is furthermore protected from physical “junk mail” since the initial company approach/offer is not directly to a physical address.

In summary, to receive a gift, the recipient does not need to pre-register for the service, since their physical address is only subsequently obtained and stored against their virtual address which is communicated in an order. However, once the recipient has responded to the downlink call message, the recipient is effectively registered and therefore recognizable by the system.

Failure of Recipient to Respond

Should the intended recipient not respond within a predetermined period, then the administrator may optionally re-send (320) the downlink call message to solicit a response, or otherwise dispatch 328 the gift to the stored recipient address; the choice is down to the control logic and system set-up.

In the event that there is no reply after a predetermined number of attempts or a time out, the administrator may send 330 an automated message to the sender advising of “no contact” and requesting further instructions. These further instructions may take the form of a refund (less any administrative charge), a credit against a future order to be recorded against the client account or a new instruction to contact a new virtual address with a view to delivery of the gift to a physical address ultimately mapped to the new virtual address. The further instructions may be a default setting written into the administrator's control logic, or otherwise may be based on explicit sender instructions 332.

In a preferred embodiment, the administrator (at time out) can be configured to send a notification saying that the gift will be dispatched to the post code (or partially obscured physical address, e.g, 183, STREET: xxxspring drive, TOWN_ _ _ field, ZIP Code _ A 1, 2 _) should the administrator fail to receive a response within, say, 6 hours from the time of sending the reminder or he downlink call message. The administrator therefore provides the recipient with an option to reply.

Sender Authentication

In advance of the administrator releasing an instruction to deliver a gift, the administrator may be configured to undertake a sender authentication. The process ensures that a third party cannot impersonate a sender and thereby send a gift to a recipient when posing as the sender. Putting this differently, the authentication process acts to prevent the recipient believing that the gift was sent by person X (when in fact the gift was sent by person Y).

Authentication generally occurs at a point after the sender's order has been processed and a related financial transaction has been cleared by the administrator 16. Of course, authentication can occur at different time, including contemporaneously with (or in) an uplink communication that accompanies the personal message and the virtual contact communicated to the administrator 16.

The purpose of authentication is to ensure that the sender is who it/they purport to be.

In one exemplary authentication process, the administrator buffers the sender's order instruction in the sender's account and only releases the instruction to deliver the gift once a messaging handshake conveys a predetermined password or access code, i.e. once an authenticated handshake takes place. For example, in response to the order, the administrator may return a short code related to the specific order to the sender's registered number of the sender's smartphone (as obtained from the sender's account), with the sender then tasked with replying to the short code to confirm that the order is legitimate. Alternatively, the sender may be required to enter an authentication code in advance of the order being made or after the order is made; this may be a pre-set password at the point of order or at a point of challenge.

The Direct Contact Process and First Contact

FIG. 5 is a flow process, implemented within the network of FIG. 1, of a preferred gift delivery service based on direct message routing to a recipient.

In contrast with the indirect process, the direct contact process operates a modified contact regime to the intended recipient but nevertheless still requires two messages to be sent, namely: i) a direct personal message (as opposed to a spoofed or faked indirect personal message) and ii) the second downlink call message (described above).

The process again begins with the instantiation 400 of the OrderApp and the placing of the order 402 against the unique sender identity. However, rather than to route the personal message to the administrator and then “spoof” or fake the header (in the “indirect” approach of FIG. 3—path 402 from decision block 404), the sender's smartphone temporarily drops out 406 of the OrderApp and sends 408 the personal message directly to the virtual address of the intended recipient. Returning 410 to the OrderApp, the administrator is made aware 412 that the personal message has been sent, with this contact from the sender 14 then allowing the administrator to send 414 the second downlink call message to the recipient's virtual address (which is in any event sent to the administrator 16). The act of placing the order through the administrator can, in fact, infer 416 that direct contact will be made by the sender to the recipient within a short period of time.

Sending the second downlink call message earlier than the first personal message is possible, but there is a chance that the message timing would cause the recipient 22 to ignore the second downlink call message by treating it as spurious or spam.

Registration and fulfillment of delivery of the gift then follows the process outlined above, including the steps of (in no particular order): authentication of the sender; receipt of the uplink reply notifying the administrator of the recipient's real-world delivery address; registration of the recipient (if needed); follow-up in the event that the administrator does not receive the expected uplink reply. The administrator can resolve delivery to the recipient based, preferably, on the recipient receiving and then quoting to the administrator the sender's unique identity. Other mechanisms for closing the loop and resolving a specific sender order against a specific virtual identity of a recipient may also be employed, including inference based on relative message event sequencing and the administrator resolving that the sender has identified the specific virtual identity and the recipient has responded to the administrator from the specific virtual identity.

The direct process is employed in territories where indirect routing and header spoofing or faking are objectionable. However, the net effect achieved by both the indirect and direct processes is the same, namely that (1) a sender is able to send a gift to a virtual address without knowledge of the physical real-world address of the recipient and (2) the recipient is able to receive a gift without having proactively to pre-register with the administrator. In the latter respect, the initial contact with the recipient is reactive, although future contact to and delivery of goods to the recipient does not require any form of response from the recipient. Indeed, with any subsequent delivery of a gift, even the personal message can be omitted, although sending of a personal message to the recipient is preferably because that personal message always points the recipient to an originator (i.e. the sender 14) of the gift.

Subsequent Orders to a Registered Recipient

Once a gift associated with a first order has been dispatched and the recipient registered in the database 18, the process of messaging and delivery can be simplified for subsequent orders. More specifically, although personal messages are preferably always sent (either directly or indirectly) to forewarn a recipient to expect a gift 26, the sender 14 merely needs to notify the administrator of the gift and the virtual address of the recipient, whereafter the administrator 16 can identify the physical delivery address (associated with the intended recipient) from its database 18 and then send the gift 26. Indeed, dispatch could occur without any attempt by the administrator to contact the intended recipient in a secondary message, although it is preferable that the recipient be notified by use of the downlink call message (described above) so as to allow the recipient to change its physical address for delivery.

However, as one option, a personal message sent by the sender may also act as a warning and a recipient may subsequently respond directly to the administrator in order to release the ordered gift by replying, e.g. sending a linked SMS message, to the administrator saying “yes, I've received a direct personal message, so please use my registered address” or “no, please update your delivery records to new address #, STREET NAME, TOWN, STATE, ZIP CODE”. This contrast with the preferred system arrangement where the administrator sends a secondary message that solicits a response to implied acceptance from the identified recipient.

Voice Gift Messaging

As a variant to a text-based personal message, another embodiment makes use of a recording facility at the administrator 16. At the point of placing an order, the sender 14 provides a sound bite that is recorded against the sender account and recipient's virtual contact address for that order. The sound bite is then relayed in a message to the intended recipient by the administrator 16, with the recipient acquiring a higher level of assurance from recognition of the sender's voice and/or message content. The message may be augmented by a supplementary message (pre-prepared by the administrator and stored in the database 18) that provides a verbal instruction detailing how the gift can be obtained. The voice messaging may occur at the point of first contact to a new recipient or at any other time with a registered recipient.

Voice gift messaging can therefore follow the flow paths outlined in FIGS. 3 to 6, albeit that the personal message is a voice message.

Indeed, voice ordering may be practised within the system so as to permit ordering of a gift to a virtual address through a more limited landline phone. In this respect, a landline call is established from the sender 14 to the administrator, with the sender then providing—in a preferred case reciting—the virtual contact address details for the recipient, the sender's unique identity and the personal message in response to verbal prompts. Some data entry may optionally be via DTMF touchtone codes (or the like) and the use of the telephone keypad. In a fully automated arrangement, the recited information is subjected to voice recognition processing to permit control logic at the administrator to extract salient information required for addressing and order completion. In contrast, the personal message is simply recorded for timely packaged delivery to the recipient.

To claim a gift that is notified by a voice message, the recipient authenticates who they are and the real world delivery address. The recipient would therefore respond to the voice message, such as through a text, voice recognition or web-based instruction.

Intermediate Company Ping

The system of FIG. 1 may further include one or more retailers 30 connected into the network 12. These retailers offer online goods and services, typically via a web browser.

The system can be further adapted such that a sender 14 interacts with the administrator through an intermediate third party retail website. In this instance, the third party retail website is augmented with a “ping” purchase button, with the sender 14 interacting with administrator-based software accessed through a portal of the retail website. More specifically, the sender 14 establishes a secure account via the retail website to permit financial transactions to be completed at and by the administrator's servers. The retail website therefore provides an embedded “use” portal in its proprietary website that seamlessly links to the administrator's management system that operates to set up the initial order or transaction and then functions to administer account payment/settlement and resolve real world delivery addresses.

At the point of completion of an online order, the sender elects the “ping” purchase that permits the sender to generate a personal message and for that message to be routed to the intended recipient by the administrator's server. The retail website therefore acts as a window to what is available, with the administrator concluding the sales transaction and arranging dispatch and delivery to a real world address. Any order received and processed by the administrator's system intelligence is inherently linked to the particular retailer web site.

In a similar fashion described above, the sender 14 uploads a virtual contact address (such as an email account name or cellphone number) to the administrator's server via the presented web portal controlled by retailer's web server, which web server then acts to relay the personal message to the virtual contact address. This relaying preferably includes spoofing or faking of the sender's identity so that assurance can be obtained by the recipient. Of course, the spoofing of the header is optional and the personal message may be relayed directly from the sender to the recipient to say, in effect, “I've ordered you a gift from the Retailer website ABC. You'll be contacted by “Parcel Genie”, the administrator 16, in a second independent email or message that requests delivery address details. Please let them, know where you'd like the gift delivered”.

Selection of the “ping” purchase also acts as a trigger establishment of a communication session between the web server of the retailer and the administrator, with the communication session permitting the administrator to acquire information pertaining to at least the retailer and the virtual contact address of the recipient, but preferably also details concerning the identity of the gift and/or the identity of the sender 14.

Armed with the virtual contact address of the recipient, the administrator operates to establish a downlink call message to the recipient that requests the recipient to return a real-world physical address detail for where the gift is to be sent. The administrator 16, upon receipt of the physical address, stores the relationship between the virtual address and physical address (as described above for potential future use) and notifies the retailer web server that a completed order is ready; this is typically achieved through the administrator providing a suitably enabled application program interface. Once the retail server is notified of the order, the delivery details (including the physical address) are passed to and injected into the retailer's proprietary order processing system. The retailer's web server can then complete the order by dispatching the ordered gift directly to the recipient.

Again, with the retailer or sender knowing the recipient's physical address, a product or service can be delivered to the recipient physical address.

Subsequent order progress as described above. Similarly, subsequent orders may be subject to the sender authentication process described above as well as the failure/recovery mechanism that requires confirmation by the recipient that any registered physical address remains a viable and usable delivery address.

Text Yourself Ordering and Text Message Gifting

In another aspect of the invention that can operate in a complementary or independent sense to the gift messaging in which the sender has no knowledge of the physical address of the recipient, the administrator is configured to operate as a virtual clearing house for a financial transaction. FIGS. 6a and 6b collectively represent a flow process through a “text-yourself” ordering methodology according to another aspect of the invention.

Briefly referring to FIG. 1, it is noted that the system 10 may include a Telco router 50 that administers telephone calls and text messaging, with the telco router 50 coupled to the network 12. Installed 600 on the telco router 50 is an application program interface (“API”) that executes control logic to administer, respond to and process SMS messages (and the like) received from the sender 14. The Telco router 50 is therefore connected to a rule engine 54 that cooperates with the API 52, and which rule engine 54 contains a modifiable instruction set that defines telco interactions as well as limited sender-related data. The sender-related data pertains, for example, to the identities of registered system users who have subscribed to the text ordering and text message gifting services described below.

One of the issues with connection to an administrator 16 is that data security generally demands that some form of log-in code is provided by the sender to verify access and appropriateness of the communication session. However, it is not unusual for a sender to have many log-in codes for different accounts and for the sender to forget a particular log-in. This aspect of the invention allows the sender to approach purchase of goods or services in a different fashion.

At the outset, the sender 14 accesses the API 52 and preferably registers 602 for a “text yourself” or “text message gifting” ordering service; this registration is stored in the rule engine against the sender's unique phone number. The sender then sends 604 a text message that conventionally is routed via the Telco router 50.

The API 52 and rule engine 54 cooperate 606 to capture text messages that have a common “looped” sender and recipient number, with the API 52 (i.e. the control intelligence in the router 50) inspecting the content of the text message (or functionally equivalent, e.g. MMS) against pre-defined rules in the rule engine. The objective of the inspection is to look for and identify 608 stored trigger words or trigger images within the message, e.g. “buy for me”, and if these are present then selectively to pass 610 the message to the administrator 16 for further processing and acquisition of an order for goods or a service. If the looped message is not assessed (path 612) to contain the trigger, the API 52 steps back from the interception and interpretation procedures and functions to forward 614 the message to the intended addressees.

An identified looped message provides a process, firstly, that mitigates the use of a log-in since the sender is authenticated through having replied to the shortcode verification request or has entered the code sent to them via their mobile number. Secondly, if interpreted by the API (having regard to rules in the rule engine 54) as a self-order, the API routes the message to the administrator 16 for additional support in the securing of the product or service against the sender's account.

To implement this ordering scheme, efficiency requires pre-registration of the user.

In more detail, an initial text message from the sender 14 contains a field that identifies a product code and includes the trigger word, trigger phrase or passcode. At the router, an embedded API (provided by the administrator) resolves 606 the looped addressing back to the sender and responds to a trigger word, trigger phrase or password by setting up a call to the administrator 16. In that call, the initial text message is communicated 610, with the administrator further referencing 612 its database to acquire an understanding of the sender's registered account.

The administrator 16 may be configured to respond 614 to the initial text message (routed via the teleco router 50) to acquire more information about the nature of the product or service to be ordered, including name of the retailer or supplier. As necessary, the sender 14 will consequently provide 616 one or more additional text responses to the administrator to permit the API to acquire a detailed understanding of the order and to permit the administrator to complete the order with the retailer and to debit the sender's account held in the database 18 coupled to the administrator 16. This dialogue excludes the sender's sent message being returned to them as a normal text message delivery. The message path of the administrator is identified through the header information conventionally included in the initial text message and the reply.

Once the administrator has acquired 618-620 a complete order, a financial transaction can be managed 622 by the administrator against the sender's account and an instructing 624 message or email can be communicated directly to the web-site of the retailer to permit the retailer to dispatch 626 the goods or services to the physical address logged against the sender and stored in the database 18.

In text gift messaging, the sender loops the address back to himself, with the router interpreting the loop message as an “order” in the event that the message includes a trigger work or phrase that means that the message is passed on to the server of the administrator. As the name suggests, the process invokes delivery of a gift using the processes of, for example, FIG. 3 in combination with the access strategy of FIGS. 6a and 6b.

The administrator's server may need to operate a multiple interrogation process based on the level of content in the initial or subsequent messages. For example, the initial message may simply include the word “buybyphone” to instantiate the application. However, in itself, this is insufficient to identify the recipient or product, although any pre-registration process may associate the cellphone number against a stored account and for financial re-charging purposes. The interrogation, which is preferably SMS based and therefore routed to the administrator via the Telco router, then seeks confirmation (over one or more steps) about the nature of the gift and who is it for. For example, the interrogation and interaction may follow the exemplary path of:
i) Identify third party virtual address (for “text gift messaging”), or confirm that order is personal to the sender (for “text yourself ordering”);
ii) What's the product or service? e.g. product QR code, captured image and/or description:
   SMS response from sender, such as “Bristol Temple Meads Station Car Park, 2 hour parking”.
iii) Is it this product [supply image or description]?
   A verification response from the subscriber/sender may be required if the suggested product is subject to any form of search.
iv) Confirm point of purchase, e.g. shop name.
   SMS response from sender.

Preferably, goods or service identifiers are stored on the administrator server's databases. Furthermore, goods or service identifiers are stored against a particular retailer. Product identity may also be identified by inference from a data scrape against a particular price or location, but this increases the possibility for error.

Unless specific arrangements are mutually exclusive with one another, the various embodiments described herein can be combined to enhance system functionality and/or to produce complementary functions in the effective delivery of a gift. Such combinations will be readily appreciated by the skilled addressee given the totality of the foregoing description. Likewise, aspects of the preferred embodiments may be implemented in standalone arrangements where more limited functional arrangements are appropriate. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

The present invention may be provided in a downloadable form or otherwise on a computer readable medium, such as a CD ROM, that contains program code that, when instantiated, executes the link embedding functionality at a web-server or the like.

It will, of course, be appreciated that the above description has been given by way of example only and that modifications in detail may be made within the scope of the present invention. For example, at the point of set-up, it is not necessary to record financial details, since these can be secured at the point of first order or otherwise at each time of placing an order. However, recording secure banking details only once (rather over a number of successive events) is preferable since it reduces the data transfer burden of sensitive client (i.e. sender) details.

Unless the surrounding context otherwise requires a more limited interpretation, the term “gift” should be interpreted widely to be any good or service that is to be delivered to a physical address of a virtually-identified recipient. The gift, although possibly subject to a financial transaction, does not necessarily require the sender to meet any financial commitment.

The skilled addressee will appreciate that process steps may be performed in a different sequence from that described, subject to the re-arranged steps and procedures securing the same technical result of allowing a product or service to be sent or order by a third party without that third party necessarily possessing the real world delivery address.

It will be understood that the administrator of FIG. 1 can, in fact, be considered as a retail entity operating a website through which products and/or services can be purchased. However, the administrator is typically realized as a standalone customer service. Unless a specific context in this description and appended claims requires a limited interpretation, the term “product” should be understood to include goods and/or a service that is delivered subject either to a financial charge or free, as the case may be. Also, the terms “fake” or “faking” and “spoof” or “spoofing” should be considered to be equivalent since they represent a process of suggesting the origin of a message emanates directly from the sender, rather than factually from an intermediary device or system, namely the administrator.

Use of the term “electronic message” should be understood to relate to any wireless or wireline communication protocol that makes use of an electronic device to assembly and send a data message, including a packet-based message (such as an email) or its equivalent. The term therefore encompasses SMS and other signalling schemes employed in the electronic communication of data.

It will be further appreciated that the operating instructions, especially the OrderApp software may be provided in the form of a software product delivered in a tangible form on a CD ROM or the like or otherwise by way of an electronic download of program code.

1. A method of delivering a product to an order recipient having a real-world delivery address potentially unknown to a registered user responsible for placing an order for the product at an administration system configured to manage order transactions for registered users and to authorize delivery of products to order recipients, the method comprising:
over a communications network, communicating an order message from a communication device to the administration system, the order message including a unique sender identity associated with the registered user, a virtual recipient address of the order recipient and a transaction instruction related to the product to be delivered to said order recipient;
at the communication device, generating at least part of a personalized message and initiating electronic communication thereof to the virtual recipient address;
at the administration system, receiving the order message and approving delivery of said order subject to correlating the unique sender identity against a registered account for the registered user and settling the transaction instruction against the registered account;
at the administration system, sending a downlink call message to the virtual recipient address, the downlink call message designed to solicit return of, or confirm, a real-world delivery address from the order recipient;
at the administration system, subsequent to receipt of the requested real-world address in a message sent from the virtual recipient address, resolving a relationship between the virtual recipient address and the real-world delivery address and instructing delivery of the product to the real-world delivery address of the order recipient.

2. The method according to claim 1, further comprising:
sending the personalized message indirectly to the virtual recipient address by relaying the personalized message through the administration system; and
upon relaying the personalized message to the virtual recipient address in a first electronic message, obscuring involvement of the administration system responsible for relaying the personalized message by spoofing the header of the first electronic message.

3. The method according to claim 2, further including augmenting the first electronic message with registered user attributes stored at the administration system.

4. The method according to claim 1, further comprising:
at the administration system, storing the real-world delivery address against the virtual recipient address to register the order recipient; and
attempting to use the stored real-world delivery address for future orders addressed to the order recipient.

5. The method according to claim 1, further comprising:
instantiating an OrderApp on the communication device;
placing an order by communicating the order message to the administration system;
temporarily dropping out of the OrderApp to configure and send a personalized electronic message directly to the virtual recipient address; and
at the administration system, sending the downlink call message after a delay, upon receipt of the order or after notification that the personalized electronic message has been sent to the virtual recipient address.

6. The method according to claim 6, wherein the administration system sends the downlink call message after a delay or after receiving notification that the personal message has been sent directly to the order recipient.

7. The method according to claim 1, wherein the virtual recipient address is selected from the group consisting of:
a cellphone number;
a telephone number; and
a social media account.

8. The method according to claim 1, wherein the personalized message content referring to the order and cross-referencing the administration system.

9. An administration system configured to manage order transactions of registered users and to authorize delivery of products to order recipients, the administration system comprising:
a server configured:
to receive and be responsive to an order message having a unique sender identity associated with a registered user, a virtual recipient address of a first order recipient and a transaction instruction related to a product to be delivered to said first order recipient;
to approve delivery of said product subject to correlating the unique sender identity against a registered account for the registered user and settling the transaction instruction against the registered account stored in a database of registered users;
following sending of a personalized message referring to the order, to assemble and send a downlink call message to the virtual recipient address, the downlink call message soliciting return of, or confirmation of, a real-world delivery address from the order recipient;
to receive the solicited real-world address in a message received from the virtual recipient address; and
to resolve a relationship between the virtual recipient address and the real-world delivery address, whereafter the server is arranged to issue an instruction for delivery of the product to the real-world delivery address of the order recipient.

10. The administration system of claim 9, wherein the system is arranged to receive at least part of the personalized message from the registered user and the server is configured to initiate electronic communication thereof to the virtual recipient address.

11. The administration system of claim 10, wherein the server is arranged to augment the personalized message with registered user attributes that are stored in the database.

12. The administration system of claim 10, wherein the server is arranged:
to store in the database the real-world delivery address against the virtual recipient address, thereby registering the order recipient; and
to attempt to use the stored real-world delivery address for future orders addressed to the order recipient.

13. The administration system of claim 10, wherein the server receives the personalized message from a networked communication device and is further arranged to relay the personalized message to the virtual recipient address, the server configured to spoof the header of the first electronic message to suggest direct communication of the personalized message as originating from the networked communication device.

14. The administration system of claim 10, wherein the personalized message refers to the order and cross-references the administration system.

15. A web-server of an on-line retailer, the web-server presenting a web page through which retail activity may be managed by the web-server, the web-page including a web portal that links through a network to the administration system of claim 9 and wherein the administration system is configured to:
set-up and manage an order or transaction;
administer account settlement; and
resolve real world delivery addresses.

16. The web-server according to claim 15, wherein the web portal is configured such that, at completion of an online order by a user, the user is prompted to generate a personal message to an intended recipient of the online order and the administration system is arranged, upon receipt of the personal message, to communicate the personal message to the intended recipient.

17. The web-server according to claim 15, wherein the administrator is arranged to:
conclude the sales transaction and to link the sales transaction to the on-line retain; and
arrange dispatch and delivery to the real world delivery address.

18. The web-server according to claim 16, wherein the web portal is configured such that, at completion of an online order by a user, a communication session between the web-server and the administrator is established and the user, wherein the communication session permits the administration system to acquire information pertaining to at least the retailer and the virtual recipient address of the intended recipient.

19. The web-server according to claim 16, wherein the web-server is configured to receive a confirmatory message from the administration system that said order has been completed by the administration system and wherein the web-server is further arranged to send an order completion message to an order processing system of the online retailer, the order completion message causing the order processing system to dispatch the order directly to the intended recipient.
